(19) United States
(12) Patent Application Publication
(10) Pub. No.: US 2014/0253462 A1
(43) Pub. Date: Sep. 11, 2014

(54) SYNC SYSTEM FOR STORING/RESTORING STYLUS CUSTOMIZATIONS

(71) Applicant: BARNESANDNOBLE.COM LLC, New York, NY (US)

(72) Inventor: Kourtny M. Hicks, Sunnyvale, CA (US)

(73) Assignee: barnesandnoble.com llc, New York, NY (US)

(21) Appl. No.: 13/793,235

(22) Filed: Mar. 11, 2013

(51) Int. Cl. G06F 3/0354

(52) U.S. Cl. CPC G06F 3/03545
USPC 345/173

(57) ABSTRACT

Techniques are disclosed for restoring stylus customizations using a stylus sync system on a touch sensitive device. The stylus customizations may relate to the stylus functionality and/or control features, for example. The sync system stores the customizations from a first stylus such that those customizations can be later restored to a second stylus. For example, the sync system may allow a user to restore stylus customizations to a replacement stylus, a borrowed stylus, or an upgraded or otherwise new stylus. This allows the user to maintain previously selected customizations without having to manually re-program each one individually. Once the stylus customizations are restored to the second stylus, the sync system can store any additional customizations made to this second stylus such that those customizations can be later restored to a third stylus, and so forth.

### FIELD OF THE DISCLOSURE

This disclosure relates to electronic computing devices, and more particularly, to a sync system for storing and restoring stylus customizations using a touch sensitive device.

### BACKGROUND

Electronic display devices such as tablets, eReaders, smart phones, personal digital assistants (PDAs), and other such touch sensitive electronic devices are commonly used for displaying consumable content. The content may be, for example, an e-book, an online article, images, documents, or video, just to name a few types. Such devices are also useful for displaying a user interface that allows a user to interact with the displayed content. The user interface may include, for example, one or more touch screen controls and/or one or more displayed labels that correspond to nearby hardware buttons. The touch screen display may be backlit or not, and may be implemented for instance with an LED screen or an electrophoretic display. Such devices may also include other touch sensitive surfaces, such as a track pad (e.g., capacitive or resistive touch sensor) or touch sensitive housing (e.g., acoustic sensor). The user may interact with the touch sensitive surfaces using fingers and/or styluses. The use of a stylus may enhance the user's experience when interacting with touch sensitive devices. For example, using a stylus may increase the user's input accuracy or comfort, especially when writing or drawing on the touch sensitive surface.

### BRIEF DESCRIPTION OF THE DRAWINGS

FIGS. 1a-b illustrate an example electronic touch sensitive device having a stylus sync system, in accordance with an embodiment of the present invention.

FIG. 1c illustrates an example stylus for use with an electronic touch sensitive device, configured in accordance with an embodiment of the present invention.

FIGS. 1d-e illustrate example configuration screen shots of the electronic touch sensitive device shown in FIGS. 1a-b, configured in accordance with an embodiment of the present invention.

FIG. 2a illustrates a block diagram of an electronic touch sensitive device, configured in accordance with an embodiment of the present invention.

FIG. 2b illustrates a block diagram of a communication system including the electronic touch sensitive device of FIG. 2a, configured in accordance with an embodiment of the present invention.

FIG. 2c illustrates a block diagram of an example stylus for use with an electronic touch sensitive device, configured in accordance with an embodiment of the present invention.

FIG. 2d illustrates a block diagram showing a communication link between the electronic touch sensitive device of FIG. 2a and the stylus of FIG. 2c, according to one embodiment of the present invention.

FIGS. 3a-c illustrate example store and restore functions using a stylus sync system, in accordance with an embodiment of the present invention.

FIG. 4 illustrates a method for storing and restoring customizations using a stylus sync system for a touch sensitive device, in accordance with an embodiment of the present invention.

### DETAILED DESCRIPTION

Techniques are disclosed for restoring stylus customizations using a stylus sync system on a touch sensitive device. The stylus customizations may relate to the stylus functionality and/or control features, for example. The sync system stores the customizations from a first stylus such that those customizations can be later restored to a second stylus. For example, the sync system may allow a user to restore stylus customizations to a replacement stylus, a borrowed stylus, or an upgraded or otherwise new stylus. This allows the user to maintain previously selected customizations without having to manually re-program each one individually. Once the stylus customizations are restored to the second stylus, the sync system can store any additional customizations made to this second stylus such that those customizations can be later restored to a third stylus, and so forth.

General Overview

As previously described, styluses are sometimes used to interact with touch sensitive devices. In some cases, styluses may include customizable functions or control features, or other customizable options. When a new or borrowed stylus is used, a user may not want to manually re-program all of the previously chosen customizations to that new or borrowed stylus.

Thus, and in accordance with an embodiment of the present invention, techniques are disclosed for restoring stylus customizations using a stylus sync system on a touch sensitive device. Stylus customizations may relate to, for example: stylus functionality, stylus control features, stylus displays, stylus memory, and/or stylus security. The sync system stores any such stylus customizations, whether those customizations are made through the device or the stylus, to allow for the stored customizations to be later restored to a different stylus. This is useful, for example, where a user loses the stylus and has to purchase a new one, forgets the stylus and borrows a different stylus temporarily, changes to a new stylus model, or repairs an old stylus (effectively making it new).

The sync system may be configured to store customizations in different ways, such as storing them after each new customization is made or storing them based on a scheduled time (e.g., once a week). In some instances, the sync system may allow stylus customizations to be stored after manual user requests, such as through a selection on the device or the stylus. The sync system may be configured to store the stylus customizations on the touch sensitive device or to server storage (e.g., cloud-based store function). Once the customizations associated with the first stylus have been stored, they can be restored to a second stylus, thereby preventing the need for a user to manually reconfigure this new or borrowed stylus with the user's previously chosen customizations. Once the stylus customizations have been restored to a second stylus, the sync system can be configured to continue storing stylus customizations, although now the customizations are those associated with this new/borrowed (second) stylus. This will allow future restoration to a third stylus, and so forth. Numerous variations and configurations will be apparent in light of this disclosure.

### Device and Stylus Examples

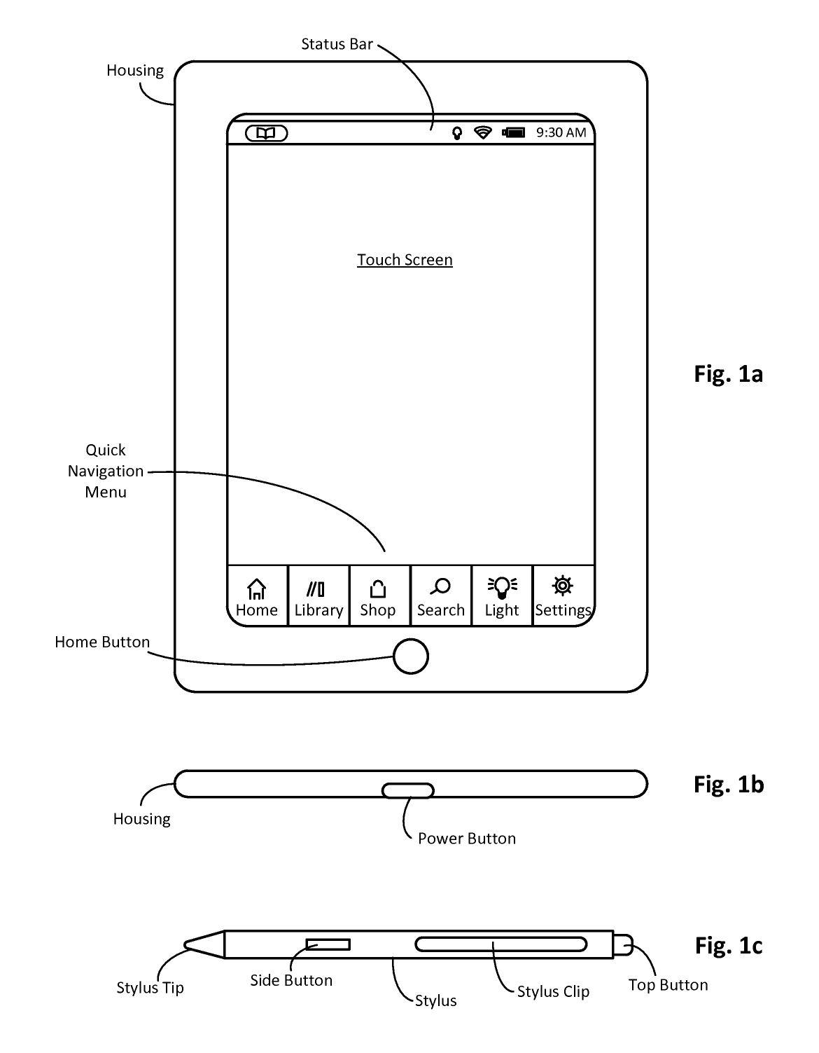

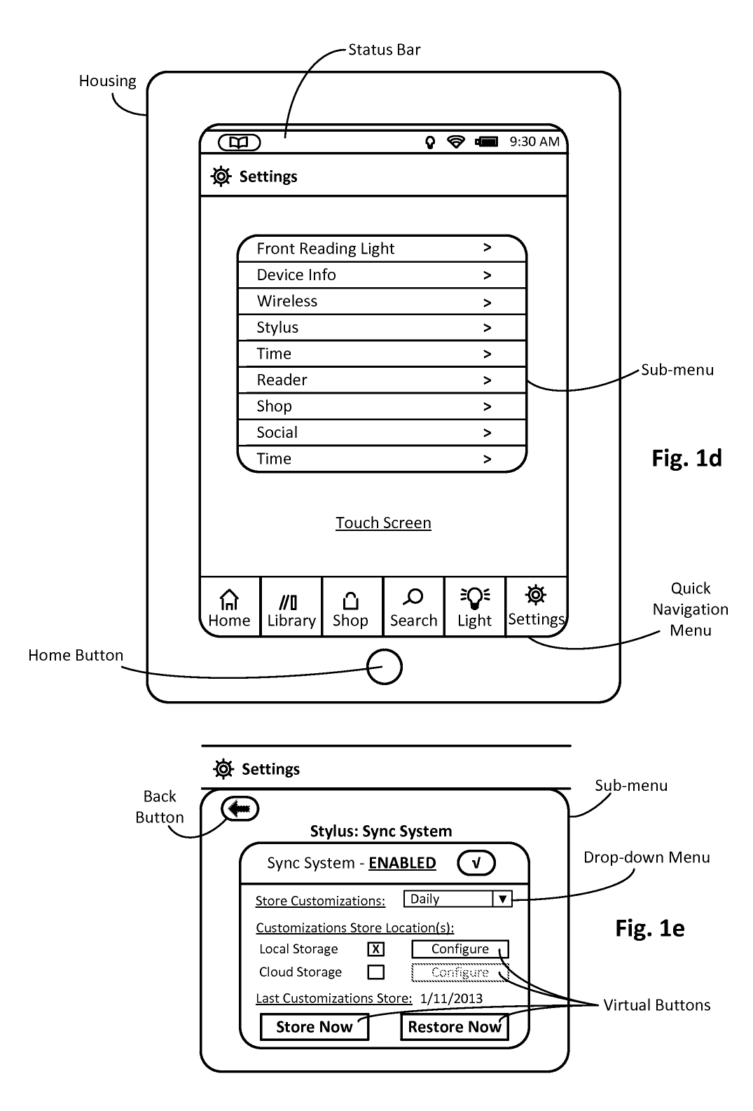

FIGS. 1a-b illustrate an example electronic touch sensitive device having a stylus sync system, in accordance with an embodiment of the present invention. The device could be, for example, a tablet such as the NOOK® tablet or eReader by Barnes & Noble. In a more general sense, the device may be any electronic device having a touch sensitive user interface. The device may also have capability for displaying content to a user, such as a mobile phone or mobile computing device such as a laptop, a desktop computing system, a television, a smart display screen, or any other device having a touch screen display or a non-touch display screen that can be used in conjunction with a touch sensitive surface. As will be appreciated, the claimed invention is not intended to be limited to any particular kind or type of electronic computing device.

As can be seen with this example configuration, the device comprises a housing that includes a number of hardware features such as a power button and a press-button (sometimes called a home button herein). A touch screen based user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such user interface (UI) touch screen features, or different UI touch screen features altogether, depending on the target application of the device. Any such general UI controls and features can be implemented using any suitable conventional or custom technology, as will be appreciated.

The power button can be used to turn the device on and off, and may be used in conjunction with a touch-based UI control feature that allows the user to confirm a given power transition action request (e.g., such as a slide bar or tap point graphic to turn power off). In this example configuration, the home button is a physical press-button that can be used as follows: when the device is awake and in use, tapping the button will display the quick navigation menu, which is a toolbar that provides quick access to various features of the device. The home button may also be configured to cease an active function that is currently executing on the device, such as a stylus sync system restore function as described herein. The button may further control other functionality if, for example, the user presses and holds the home button. For instance, an example such push-and-hold function could engage a power conservation routine where the device is put to sleep or an otherwise lower power consumption mode. So, a user could grab the device by the button, press and keep holding as the device was stowed into a bag or purse, to provide one physical gesture that would safely put the device to sleep. Thus, in such an example embodiment, the home button may be associated with and control different and unrelated actions: 1) show the quick navigation menu; 2) exit a configuration sub-menu; and 3) put the device to sleep. Numerous other configurations and variations will be apparent in light of this disclosure, and the claimed invention is not intended to be limited to any particular set of hardware buttons or features, or device form factor.

FIG. 1c illustrates an example stylus for use with an electronic touch sensitive device configured in accordance with an embodiment of the present invention. As can be seen, in this particular example, the stylus includes a stylus tip used to contact (or otherwise hover over) the touch sensitive surface (e.g., through direct or proximate contact), a stylus clip, and control features including a top button and a side button along the shaft of the stylus. In this example, the stylus tip has a triangular shape, while in other examples, the stylus tip may be more rounded, or any other suitable shape. The stylus tip may be made of any number of materials of different textures and firmness depending on the needs of the specific touch sensitive device. The styluses used with the sync system may include fewer or additional control features than the top and side buttons illustrated in FIG. 1c, or different control features altogether. Such control features may include, for example, a rotating knob, a switch, a sliding control bar, or any other suitable control feature that will be apparent in light of this disclosure. The styluses described herein may be a resistive or capacitive stylus, an active stylus, or any other suitable implement for interacting with the touch sensitive surface. As will be appreciated, the claimed invention is not intended to be limited to use with any particular kind or type of stylus.

As previously described, styluses used with one or more embodiments of the present invention may include various customizable options. For example, the function performed by the side button and/or top button on the stylus shown in FIG. 1c may be customized on a global basis or a specific application basis. An example global based customization might allow the user to select whether the side button performs one of the following: 1) a left click function, 2) a right click function, or 3) a home button function. An example application-specific based customization might allow the user to select whether the top button performs one of the following in a paint based program: 1) an erase function, 2) a tool toggle function, or 3) a secondary color function. As will be appreciated in light of this disclosure, while the stylus sync system can be implemented by the touch sensitive device, the customizable options being synced may be selected using a stylus or the touch sensitive device or a combination of the stylus and the device. Accordingly, the supporting circuitry and/or software used to select customizations may be included in the stylus or the touch sensitive device or a combination of the stylus and the device, as will be apparent.

To this end, the degree of intelligence and memory in styluses used with one or more embodiments of the present invention may vary. For example, some styluses used with an embodiment of the sync system may include enough intelligence and memory to allow for the selection and/or storage of some or all of the customizable stylus options. In some cases, the customizable options available will depend on the specific hardware/software/firmware of the stylus and/or the touch sensitive device. Whether the customizable options are selected from the touch sensitive device or the stylus, those customizations are then stored using the sync system described herein to later restore previously selected customizations to a new/borrowed stylus. The customization syncing techniques disclosed herein apply equally to any customizable options or control features. For ease of description, stylus examples illustrated herein are provided with push button control features, but numerous other configurations will be apparent in light of this disclosure.

FIGS. 1d-e illustrate example configuration screen shots of the electronic touch sensitive device shown in FIGS. 1a-b, configured in accordance with an embodiment of the present invention. In one particular embodiment, a stylus sync system configuration sub-menu, such as the one shown in FIG. 1e, may be accessed by tapping or otherwise selecting the Settings option in the quick navigation menu, which causes the device to display the general sub-menu shown in FIG. 1d. From this general sub-menu the user can select any one of a number of options, including one designated Stylus in this specific example case. Selecting this sub-menu item (with an appropriately placed screen tap) may cause the stylus sync system configuration sub-menu of FIG. 1e to be displayed, in accordance with an embodiment. In other example embodiments, selecting the Stylus option may present the user with a number of additional sub-options, one of which may include a so-called stylus sync system option, which may then be selected by the user so as to cause the stylus sync system configuration sub-menu of FIG. 1e to be displayed. Any number of such menu schemes and nested hierarchies can be used, as will be appreciated in light of this disclosure. In other embodiments, the stylus sync system may be hard-coded such that no configuration sub-menus are needed or otherwise provided (e.g., all stylus customizations are automatically stored as described herein, with no user configuration). The degree of hard-coding versus user-configurability can vary from one embodiment to the next, and the claimed invention is not intended to be limited to any particular configuration scheme of any kind.

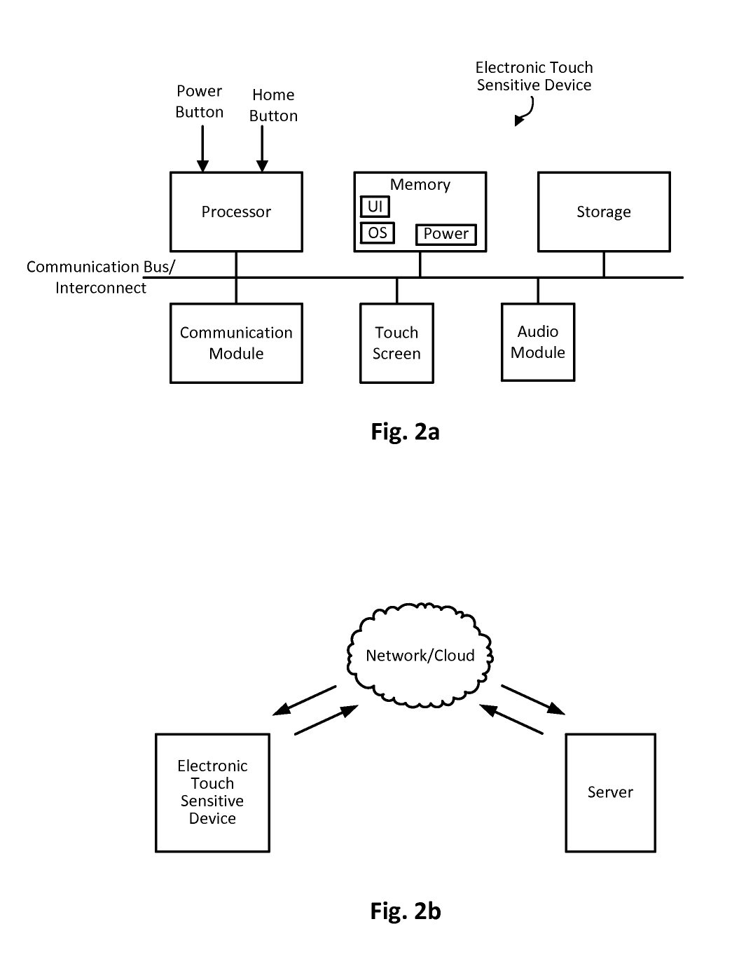

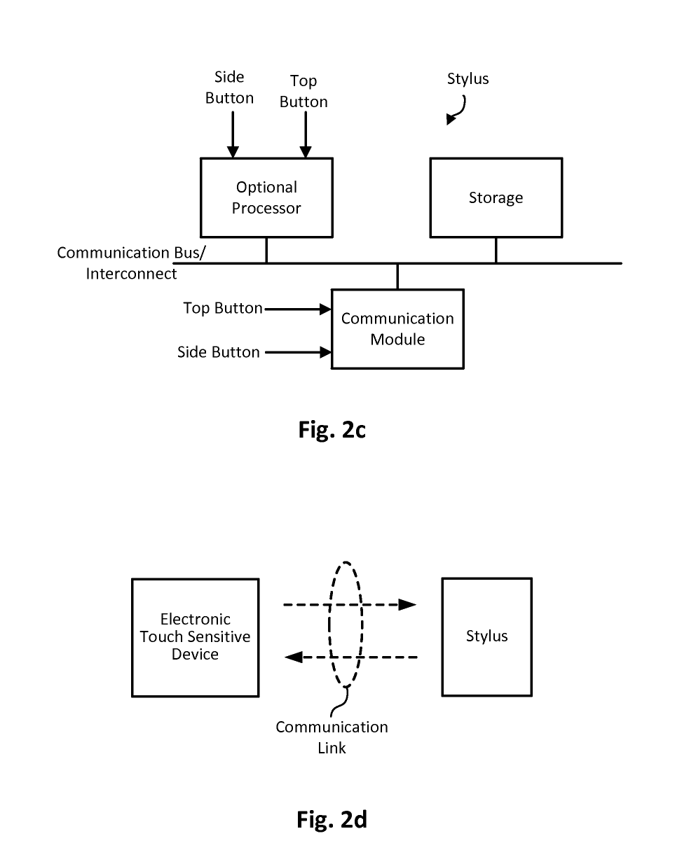

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates the user touch in a given location into an electrical signal which is then received and processed by the underlying operating system (OS) and circuitry (processor, etc.). The user touch may be performed with a finger, a stylus, or any other suitable implement, unless otherwise specified. Additional example details of the underlying OS and circuitry in accordance with some embodiments will be discussed in turn with reference to FIG. 2a.

As previously explained, and with further reference to FIGS. 1d and 1e, once the Settings sub-menu is displayed (FIG. 1d), the user can then select the Stylus option. In response to such a selection, the stylus sync system configuration sub-menu shown in FIG. 1e can be provided to the user. The user can configure a number of options with respect to the stylus sync system, in this example embodiment. For instance, in this example case, the configuration sub-menu includes a UI check box that when checked or otherwise selected by the user, effectively enables the stylus sync system (shown in the enabled state); unchecking the box disables the sync system. Other embodiments may have the stylus sync system always enabled such that customizations are automatically stored, for example. In addition, the sync system of this example case includes settings options for selecting the frequency that customizations should be stored for the stylus being used. As can be seen, this settings option is set to Daily, as indicated by the drop-down menu, which means the sync system is configured to store stylus customizations once a day. If a store event was supposed to occur and there is no communication link between the device and the stylus, the sync system will store customizations when the next communication link is established, in accordance with some embodiments. Other selectable frequencies may also include Manually (customizations stored only upon manual user requests), Automatically (customizations stored after every customization selection/change/update), Weekly, or any other suitable frequency.

As further shown in FIG. 1e, this example sync system embodiment also includes settings options for customization storage location. As can be seen in this example case, the stylus customizations can be stored to the local storage of the touch sensitive device (e.g., using the device's storage as shown in FIG. 2a) or to server storage (e.g., using the cloud/network shown in FIG. 2b). The storage locations and/or other options relating to the storage of the stylus customizations may be further configured, such as through the Configure virtual buttons shown. In this particular example, the sync system is configured to store stylus customizations to local storage, as indicated by the check boxes. The example sync system settings also include a display showing when the last customizations sync was performed. In this particular example, the last store was performed on Jan. 11, 2013. In another example, the sync system may be configured to display other information, such as the storage location, the stylus model ID being synced, or the number of customizations stored.

The sync system may also be configured with options for performing manual syncs, such as a manual stylus customizations store and/or a manual stylus customizations restore. The settings screen shown in FIG. 1e includes Store Now and Restore Now virtual buttons. The Store Now virtual button can be used to perform a manual store of current stylus customizations. The Restore Now virtual button can be used to perform a manual restore of stored stylus customizations to a new or borrowed stylus. In another example, the manual storing and/or restoring may be performed using a control feature on the stylus. The sync system may be configured to store and/or restore in any number of ways, as will be apparent in light of this disclosure, whether or not those functions are user-configurable.

As can be further seen, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Numerous other configurable aspects will be apparent in light of this disclosure. For instance, in some embodiments, the stylus sync system can be assigned on a context basis. For example, the configuration menu may allow the user to store customizations for specific applications or programs, such as the function performed by the top button of the stylus shown in FIG. 1c in a virtual paint application, as described herein. Thus, the techniques provided herein can be implemented on a global level, a content based level, or an application level, in some example cases. Again, while FIGS. 1d and 1e show user configurability, other embodiments may not allow for any such configuration, wherein the various features provided are hard-coded or otherwise provisioned by default.

Architecture

FIG. 2a illustrates a block diagram of an electronic touch sensitive device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc.). Further note that although a touch screen display is provided, other embodiments may include a non-touch screen and a touch sensitive surface such as a track pad, or a touch sensitive housing configured with one or more acoustic sensors, etc. In any such cases, the touch sensitive surface is generally capable of translating a user's physical contact with the surface into an electronic signal that can be manipulated or otherwise used to trigger a specific user interface action, such as those provided herein. The principles provided herein equally apply to any such touch sensitive devices. For ease of description, examples are provided with touch screen technology.

The touch sensitive surface (touch sensitive display in this example) can be any device that is configured with user input detecting technologies, whether capacitive, resistive, acoustic, active or passive stylus, and/or other input detecting technology. The screen display can be layered above input sensors, such as a capacitive sensor grid for passive touch-based input (such as with a finger or passive stylus in the case of a so-called in-plane switching (IPS) panel), or an electro-magnetic resonance (EMR) sensor grid (e.g., for sensing a resonant circuit of the stylus). In some embodiments, the touch screen display can be configured with a purely capacitive sensor, while in other embodiments the touch screen display may be configured to provide a hybrid mode that allows for both capacitive input and EMR input, for example. In still other embodiments, the touch screen display is configured with only an active stylus sensor. In any such embodiments, a touch screen controller may be configured to selectively scan the touch screen display and/or selectively report contacts detected directly on or otherwise sufficiently proximate to (e.g., within a few centimeters) the touch screen display. Numerous touch screen display configurations can be implemented using any number of known or proprietary screen based input detecting technology.

In one example embodiment, stylus interaction can be provided by, for example, placing the stylus tip on the stylus detection surface, or sufficiently close to the surface (e.g., hovering one to a few centimeters above the surface, or even farther, depending on the sensing technology deployed in the stylus detection surface) but nonetheless triggering a response at the device just as if direct contact were provided on a touch screen display. As will be appreciated in light of this disclosure, an styluses as used herein may be implemented with any number of stylus technologies, such as the technology used in DuoSense® pens by N-trig® (e.g., wherein the stylus utilizes a touch sensor grid of a touch screen display) or EMR-based pens by Wacom technology, or any other commercially available or proprietary stylus technology. Further recall that the stylus sensor in the computing device may be distinct from an also provisioned touch sensor grid in the computing device. Having the touch sensor grid separate from the stylus sensor grid may allow the device to, for example, only scan for a stylus input, a touch contact, or to scan specific areas for specific input sources, in accordance with some embodiments. In one such embodiment, the stylus sensor grid includes a network of antenna coils that create a magnetic field which powers a resonant circuit within the stylus. In such an example, the stylus may be powered by energy from the antenna coils in the device and the stylus may return the magnetic signal back to the device, thus communicating the stylus' location, control feature inputs, etc. Such an embodiment may also eliminate the need for a battery on the stylus.

Continuing with the example electronic touch sensitive device embodiment shown in FIG. 2a, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including a stylus sync system as described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., 800 MHz Texas Instruments OMAP3621 applications processor), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory). The display can be implemented, for example, with a 6-inch E-ink Pearl 800×600 pixel screen with Neonode® zForce® touch screen, or any other suitable display and touch screen interface technology. The communications module can be configured to execute, for instance, any suitable protocol which allows for connection to the stylus so that customizations can be transmitted to or received from styluses being used with the device for storing and/or restoring stylus customizations. Example communications modules may include an NFC (near field connection), Bluetooth, 802.11 b/g/n WLAN, or other suitable chip or chip set that allows for wireless connection to the stylus (including any custom or proprietary protocols). In some embodiments, a wired connection can be used between the stylus and device. In some specific example embodiments, the device housing that contains all the various componentry measures about 6.5″ high by about 5″ wide by about 0.5″ thick, and weighs about 6.9 ounces. Any number of suitable form factors can be used, depending on the target application (e.g., laptop, desktop, mobile phone, etc.). The device may be smaller, for example, for smartphone and tablet applications and larger for smart computer monitor applications.

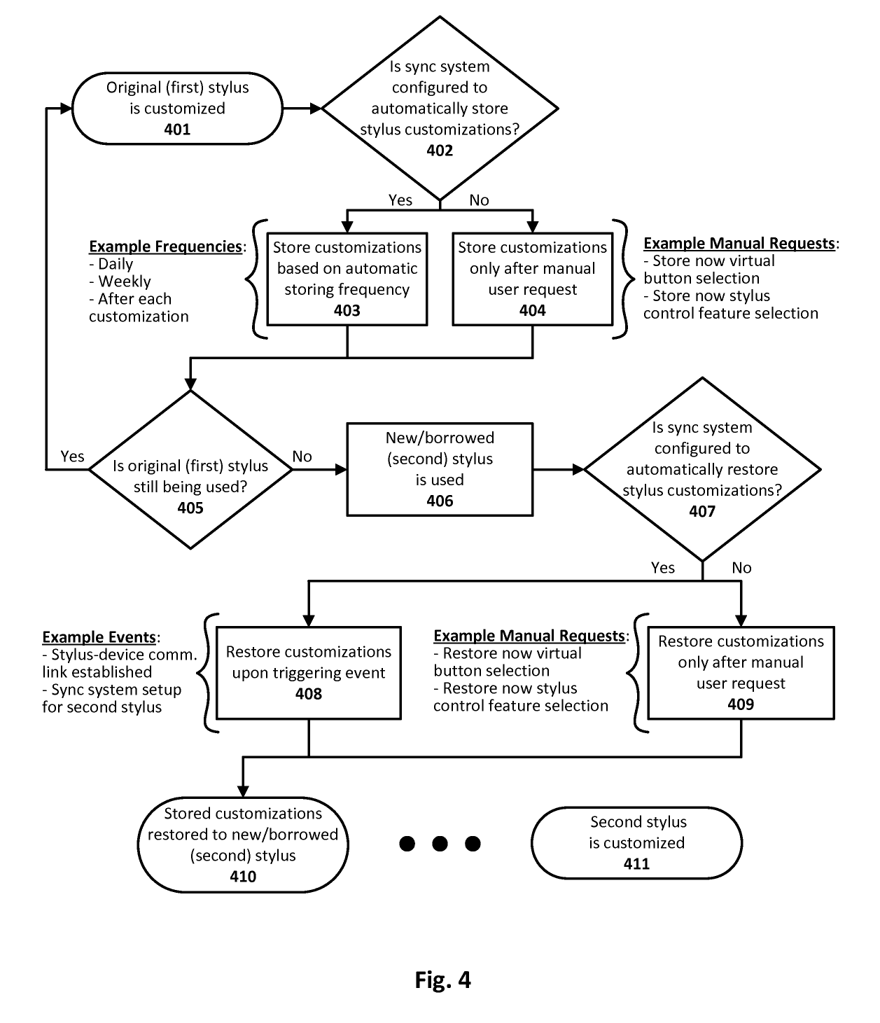

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The user interface (UI) module can be, for example, based on touch screen technology and the various example screen shots shown in FIGS. 1a, 1d-e, and 3a-c, as well as various stylus customization sync methodologies shown in FIG. 4, which will be discussed in turn. The audio module can be configured, for example, to speak or otherwise aurally present information related to stylus customizations or other virtual content, if preferred by the user. Numerous commercially available text-to-speech modules can be used to facilitate the aural presentation of the information, such as Verbose text-to-speech software by NCH Software. In some example cases, if additional space is desired, for example, to store stylus customization files as previously described or other content, storage can be expanded via a microSD card or other suitable memory expansion technology (e.g., 32 GBytes, or higher). Further note that although a touch screen display is provided, other embodiments may include a non-touch screen and a touch sensitive surface such as a track pad, or a touch sensitive housing configured with one or more acoustic sensors, etc.

FIG. 2b illustrates a block diagram of a communication system including the electronic touch sensitive device of FIG. 2a, configured in accordance with an embodiment of the present invention. As can be seen, the system generally includes an electronic touch sensitive device that is capable of communicating with a server via a network/cloud. In this example embodiment, the electronic touch sensitive device may be, for example, an eBook reader, a mobile cell phone, a laptop, a tablet, a desktop computer, or any other electronic touch sensitive computing device. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by providing the user with requested or otherwise recommended content. In some such embodiments, the server is configured to remotely provision the stylus sync system as provided herein to the touch sensitive device (e.g., via JavaScript or other browser based technology). In other embodiments, portions of the methodology are executed on the server and other portions of the methodology are executed on the device. In some instances, the stylus sync system may be configured to store stylus customizations to server storage, as previously described. In these instances, the stored customizations can then be retrieved from the server storage to restore previously selected customizations to a new or borrowed stylus. Numerous server-side/client-side execution schemes can be implemented to facilitate a stylus sync system in accordance with an embodiment, as will be apparent in light of this disclosure.

FIG. 2c illustrates a block diagram of an example stylus for use with an electronic touch sensitive device, configured in accordance with an embodiment of the present invention. As can be seen, this example stylus includes a communications module, a side button, and a top button. A communications bus and interconnect may be provided to allow inter-device communication. An optional processor may also be included in the stylus to provide local intelligence, but such is not necessary in embodiments where the touch sensitive device with which the stylus is communicatively coupled provides the requisite control and direction, including how the stylus performs based on stylus customizations. Storage may also be included in the stylus where the stylus stores selected customizations, such as the functions that the side and top button perform. Other componentry and functionality not reflected in the block diagram will be apparent (e.g., battery, speaker, antenna, etc.). The optional processor can be any suitable processor and may be programmed or otherwise configured to assist in controlling the stylus, and may receive input from the user from control features, including the top and side buttons. The storage may be implemented with any suitable memory and size (e.g., 2 to 4 GBytes of flash memory).

The communications module can be, for instance, any suitable module which allows for connection to a nearby electronic device so that data may be transmitted to and/or received from the device, including data relating to stylus customizations. In some embodiments, the stylus may be connected to a related device using a wire, where the wire allows the stylus to receive information from and/or transmit information to the related device. In other embodiments, the communication module may be wireless and use any number of short-range or long-range wireless communication technologies, such as near field communication (NFC), radio-frequency identification (RFID), Bluetooth, Wi-Fi, electromagnetic, infrared or other light communication technologies, radio frequency (RF) or other radio communication technologies, or any other suitable communication technology. In this example case, the communications module can receive input from the user from the side and top button control features, wherein such inputs can be used to enable the transmit function of the communications module. As will be appreciated, stylus customizations may be synced using a communication link established by the communication module, whether the stylus customizations are being stored or restored using the sync system. In one embodiment, the stylus includes memory storage and a transceiver, but no dedicated processor. In such an embodiment, the processor of the electronic device communicates with the transceiver of the stylus and executes functions based on stylus customizations, stores the stylus customizations, and can also restore the stored customizations to a new or borrowed stylus.

Conventional or custom discovery and handshake protocols can be used to introduce or otherwise relate a given stylus with a given device, in accordance with some embodiments. In some such cases, a software driver that comes with the stylus can be loaded onto the target electronic device, so as to enable the communication between the device and stylus as well as the functionality described herein. Such plug and play functionality can be implemented using any number of suitable self-discovery based communication protocols. Depending on the target price point of the stylus, such protocols may be heavy (e.g., Wi-Fi) or light (e.g., NFC or Bluetooth). In some embodiments, the pairing or relating of the device and stylus may be required before the sync system can store customizations relating to that stylus. The sync system may be configured to automatically restore previously stored stylus customizations as described herein when pairing or relating the device and stylus. Other embodiments may require a user to manually restore previously stored stylus customizations after the stylus has been paired or related to the touch sensitive device.

FIG. 2d illustrates a block diagram showing a communication link between the electronic touch sensitive device of FIG. 2a and the stylus of FIG. 2c, according to one embodiment of the present invention. As can be seen, the system generally includes an electronic touch sensitive device that is capable of wirelessly connecting to other devices and a stylus that is also capable of wirelessly connecting to other devices. In this example embodiment, the electronic touch sensitive device may be, for example, an e-Book reader, a mobile cell phone, a laptop, a tablet, a desktop computer, or any other touch sensitive computing device. As described above, the communication link may include an NFC, Bluetooth, 802.11 b/g/n WLAN, or other suitable communication link which allows for transfer of data between an electronic touch sensitive device and one or more styluses.

### Example Store and Restore Functions

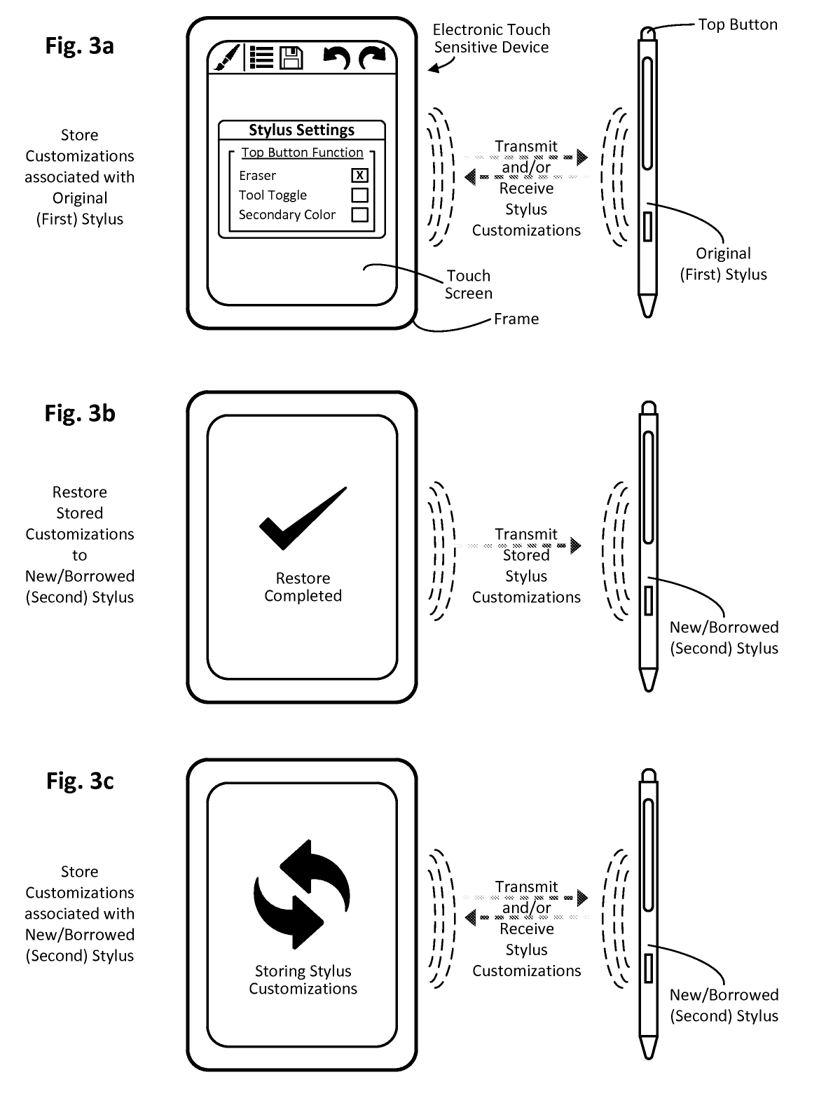

FIGS. 3a-c illustrate example store and restore functions using a stylus sync system, in accordance with an embodiment of the present invention. Generally, FIG. 3a shows the sync system storing customizations associated with an original (first) stylus, FIG. 3b shows the sync system restoring previously stored customizations associated with the original (first) stylus to a new/borrowed (second) stylus, and FIG. 3c shows the sync system storing updated customizations associated with the new/borrowed (second) stylus after the previously stored customizations were restored to that second stylus. In this example embodiment and throughout this disclosure, the first stylus is referred to as an original stylus and the second stylus is referred to as a new/borrowed stylus for ease of description; however, the original and new/borrowed modifiers are not intended to limit the claimed invention.

FIG. 3a illustrates an embodiment of a sync system storing customizations associated with an original (first) stylus. The electronic touch sensitive device shown includes the sync system and has a physical frame or support structure provided about the touch screen of the device. The device happens to be running and displaying a virtual paint application in this example scenario, indicated by the paintbrush icon in the top left corner of the touch screen. The virtual paint application also includes other icons to the right of the paintbrush icon: a menu icon, a save icon, an undo icon, and a redo icon (from left to right). These four icons may be selected to perform their corresponding functions. For instance, the menu icon can be selected (e.g., by tapping the menu icon on the touch screen with the stylus) to bring up a menu of options. After one or more menu option selections, the user may be able to configure stylus settings for the virtual paint application. For example, the Stylus Settings box displayed in FIG. 3a allows the user to customize the Top Button Function by selecting one of the available options: Eraser, Tool Toggle, or Secondary Color. In this example, the function selected corresponds to the function that is performed when the top button of the stylus is pressed. For instance, if the Eraser function is selected (such as is the case here), then the user can select the top button of the stylus to perform an erase function within the virtual paint application. In this case, the user may turn the stylus upside down and contact the touch screen with the top button when desiring to use the erase function. In another case, where the Tool Toggle option is selected for the Top Button Function, the user may toggle between virtual paint tools (such as a pen, brush, and marker) by pressing the top button. In yet another case, where the Secondary Color option is selected for the Top Button Function, the user can use the top button to draw using a secondary color in the virtual paint application.

As previously described, embodiments of the sync system may be configured to store/restore any various stylus customization and the example customization shown in FIG. 3a and described herein is merely provided for illustrative purposes. Numerous other customization schemes will be apparent, depending on factors such as the target application and the pen control features. For example, stylus customizations may relate to: favorite font settings, favorite thickness settings, favorite color settings (e.g., for writing, notes, and/or highlights), actions performed at certain stylus angles (e.g., tilted or lying flat), actions performed when directly contacting a touch sensitive device (e.g., write like a pen when used in a writing/drawing application but act like a pointer tool in other applications), actions performed when tapping the screen (e.g., one action for a single tap but a different action for a double tap), actions performed when gestures are made (e.g., one action when an X-shaped gesture is made and a different action when a Y-shaped gesture is made), hover settings (e.g., actions performed when gestures are made when hovering), actions performed when stylus is docked or undocked from device, actions performed by control features (e.g., button or knob actions), actions performed when stylus cap is on versus off, actions performed when shaking/flicking pen (e.g., side-to-side or up and down), actions performed when using the tip versus the top of the stylus, actions performed based on the pressure used (e.g., light pressure versus heavier pressure), and/or stylus display settings (e.g., display brightness, colors, and/or fonts).

Continuing with the example shown in FIG. 3a, the electronic touch sensitive device including a stylus sync system in accordance with one or more embodiments may be configured to transmit customizations to a stylus and/or receive customizations from a stylus. In this example, the transmitting and receiving of stylus customizations is performed wirelessly. In another example, where the device and stylus are connected via a wire, the transmitting and receiving of stylus customizations may be performed using the wire. In some cases, customizations may be selected using the touch sensitive device, such as in the Top Button Function example previously described. In these cases, data related to customization selections may be transmitted to a stylus such that the stylus can perform as customized. In some instances, the customization data can be stored in the stylus. Since the customizations were selected in this case using the touch sensitive device, those customizations are available to store to the sync system that is on the same device. In other cases, customizations may be selected directly from the stylus itself, without the use of the touch sensitive device. In these cases, the touch sensitive device can receive data related to customization selections from the stylus to allow the sync system to store the customizations. The communication modules of the touch sensitive device and stylus facilitate the transmitting and receiving of stylus customizations. The sync system then stores the selected stylus customizations in accordance with its configuration. For example, an automatic configuration will store stylus customizations as scheduled (or as soon as a communication link between the device and stylus is established) and a manual configuration will store stylus customizations upon a manual user request.

After stylus customizations associated with an original (first) stylus are stored, as is shown in FIG. 3a, the stored customizations can then be restored to a new/borrowed (second) stylus, as is shown in FIG. 3b. The restore function is performed by transmitting the stored customizations to the new/borrowed (second) stylus. In some embodiments, the restore function may occur automatically when the new/borrowed stylus is paired or otherwise related to the touch sensitive device running the stylus sync system. In some other embodiments, a manual user request may be required to perform the stylus customizations restore function. After the restore function has been performed, the sync system may be configured to indicate that the restore is complete. For example, the touch sensitive device in FIG. 3b is shown displaying a checkmark and “Restore Completed” to visually indicate to the user that the restore function is complete. Indications other than visual feedback may be used depending on the hardware of the touch sensitive device, such as aural or haptic feedback.

In instances where the stored customizations are being restored to a new/borrowed stylus having the same model type as the original stylus, all stored customizations are restored to that new/borrowed stylus. In these instances, after the restore, the new/borrowed stylus is customized in the same manner as the original stylus was customized during its last stylus customizations store. In instances where stored stylus customizations are being restored to a different stylus model (such as a model having different hardware or componentry), the restored customizations may only affect the control features or other aspects of the stylus that the new/borrowed stylus has in common with the original stylus. To this end, the sync system may be programmed or otherwise configured to account for the differences in stylus models and to translate, convert, or otherwise manipulate the stored customizations such that the customizations are properly restored to the new/borrowed stylus, in accordance with an embodiment of the present invention. In this regard, the stylus sync system may be configured to receive stylus model information from the stylus or touch sensitive device prior to performing the restore function to ensure that customizations are restored in an accurate fashion. In some such cases, the stylus sync system may include or otherwise have access to a data store of known stylus models and their respective customizable features, such that common or similar feature of distinct stylus models are known. The data store can be stored, for example, on the computing device with which the stylus is paired.

After the stored customizations are restored to the new/borrowed (second) stylus, as is shown in FIG. 3b, the stylus customizations associated with the new/borrowed (second) stylus may be stored, as is shown in FIG. 3c. FIG. 3c shows that after the restore function performed is completed, the new/borrowed (second) stylus becomes the active stylus, such that any new customizations made to this second stylus can be stored using the stylus sync system. In this regard, the sync system process starts over to store customizations associated with the second stylus. Thus, if any additional styluses are used with the touch sensitive device, the user can repeat the restore and store functions using the stylus sync system to ensure that user customizations continue to be captured for easy restoration. For example, if the user lost the second stylus after additional customizations were made to that stylus, but the sync system stored the customizations made, all customizations can be restored to a third stylus.

Methodology

FIG. 4 illustrates a method for storing and restoring customizations using a stylus sync system for a touch sensitive device, in accordance with an embodiment of the present invention. The touch sensitive device may be a desktop computer, laptop, netbook, tablet, eReader, mobile phone, smart phone, personal digital assistant (PDA), video game console, handheld gaming console, portable media player, or a handheld navigation system. This example methodology may be implemented, for instance, by the UI module of the touch sensitive device shown in FIG. 2a or the touch sensitive device shown in FIG. 2b (e.g., with the UI provisioned to the client by the server). To this end, the UI can be implemented in software, hardware, firmware, or any combination thereof, as is appreciated in light of this disclosure.

As can be seen, in this example case, the method starts with an original (first) stylus being customized 401. As previously described, the stylus customizations may be made by the touch sensitive device and/or the stylus. Once one or more customizations are made to the stylus, the sync system configuration determines how the customizations are stored. In this example, the method determines if the sync system is configured to automatically store stylus customizations 402. If the sync system embodiment is configured to automatically store stylus customizations, then the customizations will be stored in accordance with the chosen storing frequency 403. The frequency of the automatic stylus customization store function may be set at, for example, daily, weekly, or after each customization (see FIG. 1e for an example of how to configure the sync system based on the desired automatic storing frequency). In other embodiments, the sync system may be hard-coded to, for example, automatically store stylus customizations after each customization is made. If the sync system embodiment is not configured to automatically store stylus customizations, then the customizations may be stored only after a manual user request 404. The stylus customization store manual user request may include, for example, a virtual store now button selection (see FIG. 1e for an example store now virtual button) or a stylus control feature selection that performs the store function. In some cases, if the sync system is configured to automatically store stylus customizations as disclosed herein, it may also be configured to receive manual user requests to store customizations as well.

The method continues by determining if the original (first) stylus is being used 405. If the original stylus is still being used, then any new customizations made to that stylus can be stored according to steps 401-404. If the original (first) stylus is no longer being used and a new/borrowed (second) stylus is used 406 with the touch sensitive device running the sync system, then the restore function described herein can be performed. The method determines if the sync system is configured to automatically restore stored stylus customizations 407. If the sync system embodiment is configured to automatically restore stored stylus customizations, then the customizations will be restored upon a triggering event 408 that triggers the restore function to begin. The triggering event may include, for example, when a communication link is established between the second stylus and the touch sensitive device running the sync system or when the sync system is being setup for this second stylus. If the sync system embodiment is not configured to automatically restore stylus customizations, then the customizations may be restored only after a manual user request 409. The stylus customizations restore manual user request may include, for example, a virtual restore now button selection (see FIG. 1e for an example restore now virtual button) or a stylus control feature selection that performs the restore function. In some cases, if the sync system is configured to automatically restore stylus customizations as disclosed herein, it may also be configured to receive manual user requests to restore customizations as well.

After the customizations have been restored to the new/borrowed (second) stylus 410, the method may continue by storing updated customizations associated with this second stylus after the second stylus is customized 411. Therefore the method may start over with the second stylus replacing the first, such that customizations associated with this second stylus can be later restored to a third stylus, and so on. In some example embodiments, the sync system may be configured to allow stored stylus customizations associated with a first stylus to be restored to that same first stylus through, for example, a manual user request to restore the stored customizations. This may be useful if the first stylus somehow loses all of its customizations or a user wishes to revert back to the customized state of the stylus as previously stored.

Numerous variations and embodiments will be apparent in light of this disclosure. One example embodiment of the present invention provides a device including a touch sensitive surface for allowing user input via a stylus, and a stylus sync system configured to restore customizations associated with a first stylus to a second stylus. In some cases, the stylus sync system restores customizations wirelessly. In some cases, the stylus sync system is configured to transmit customization data to the first stylus and/or receive customization data from the first stylus and store that received customization data such that the stored customizations can be later restored to the second stylus. In some cases, the device includes storage, wherein the stylus sync system is configured to store customizations associated with the first stylus to the storage. In some cases, the stylus sync system is configured to store customizations associated with the first stylus to a remote server. In some cases, the device includes a display for displaying content to a user. In some cases, the device is one of a desktop computer, laptop, netbook, tablet, eReader, mobile phone, smart phone, personal digital assistant (PDA), video game console, handheld gaming console, portable media player, and a handheld navigation system. In some cases, the stylus sync system is user-configurable.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to receive (at a touch sensitive device) an indication that a first stylus has been replaced by a second stylus, and restore stored customizations associated with the first stylus to the second stylus. In some cases, the customizations associated with a given first stylus are stored automatically after each customization is made. In some cases, the customizations associated with a given first stylus are stored manually after a user request to store the stylus customizations. In some cases, the stored customizations are restored automatically upon a communication link between the second stylus and the touch sensitive device. In some cases, the stored customizations are restored manually after a user request to restore the stored stylus customizations. In some cases, the second stylus is the same model as the first stylus. In some cases, the second stylus is a different model from the first stylus. In some cases, the first stylus and the second stylus are the same stylus. In some cases, process is configured to store customizations associated with at least one of the first and/or second stylus on the touch sensitive device.

Another example embodiment of the present invention provides a computer program product including a plurality of instructions non-transiently encoded thereon to facilitate operation of an electronic device according to a process. In this example embodiment, the process is configured to transmit stylus customization data to a first stylus using a touch sensitive device, wherein the stylus customization data relates to customizations associated with the first stylus. The process is also configured to receive stylus customization data from the first stylus using the touch sensitive device, wherein the stylus customization data relates to customizations associated with the first stylus. The process is also configured to store the stylus customization data such that the stored stylus customization data can be later restored to a second stylus. In this example embodiment, the stylus customization data relates to at least one of stylus functionality, stylus control features, stylus displays, stylus memory, and stylus security. In some cases, the process is configured to restore the stylus customization data to the second stylus. In some cases, the touch sensitive device includes at least one communication module configured to wirelessly link to at least the first and second stylus to perform transmitting and receiving of stylus customization data wirelessly.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a touch sensitive surface for allowing user input via a stylus; and
a stylus sync system configured to restore customizations associated with a first stylus to a second stylus.

2. The device of claim 1 wherein the stylus sync system restores customizations wirelessly.

3. The device of claim 1 wherein the stylus sync system is configured to transmit customization data to the first stylus and/or receive customization data from the first stylus and store that received customization data such that the stored customizations can be later restored to the second stylus.

4. The device of claim 1 further comprising storage, wherein the stylus sync system is configured to store customizations associated with the first stylus to the storage.

5. The device of claim 1 wherein the stylus sync system is configured to store customizations associated with the first stylus to a remote server.

6. The device of claim 1 further comprising a display for displaying content to a user.

7. The device of claim 1 wherein the device is one of a desktop computer, laptop, netbook, tablet, eReader, mobile phone, smart phone, personal digital assistant (PDA), video game console, handheld gaming console, portable media player, and a handheld navigation system.

8. The device of claim 1 wherein the stylus sync system is user-configurable.

9. A computer program product comprising a plurality of instructions non-transiently encoded thereon to facilitate operation of an electronic device according to the following process, the process comprising:
receive, at a touch sensitive device, an indication that a first stylus has been replaced by a second stylus; and
restore stored customizations associated with the first stylus to the second stylus.

10. The computer program product of claim 9 wherein the customizations associated with a given first stylus are stored automatically after each customization is made.

11. The computer program product of claim 9 wherein the customizations associated with a given first stylus are stored manually after a user request to store the stylus customizations.

12. The computer program product of claim 9 wherein the stored customizations are restored automatically upon a communication link between the second stylus and the touch sensitive device.

13. The computer program product of claim 9 wherein the stored customizations are restored manually after a user request to restore the stored stylus customizations.

14. The computer program product of claim 9 wherein the second stylus is the same model as the first stylus.

15. The computer program product of claim 9 wherein the second stylus is a different model from the first stylus.

16. The computer program product of claim 9 wherein the first stylus and the second stylus are the same stylus.

17. The computer program product of claim 9 wherein the process further comprises:
store customizations associated with at least one of the first and/or second stylus on the touch sensitive device.

18. A computer program product comprising a plurality of instructions non-transiently encoded thereon to facilitate operation of an electronic device according to the following process, the process comprising:
transmit stylus customization data to a first stylus using a touch sensitive device, wherein the stylus customization data relates to customizations associated with the first stylus;
receive stylus customization data from the first stylus using the touch sensitive device, wherein the stylus customization data relates to customizations associated with the first stylus; and
store the stylus customization data such that the stored stylus customization data can be later restored to a second stylus;
wherein the stylus customization data relates to at least one of stylus functionality, stylus control features, stylus displays, stylus memory, and stylus security.

19. The computer program product of claim 18 the process further comprising:
restore the stylus customization data to the second stylus.

20. The computer program product of claim 18 wherein the touch sensitive device includes at least one communication module configured to wirelessly link to at least the first and second stylus to perform transmitting and receiving of stylus customization data wirelessly.
